(19) United States
(12) Patent Application Publication
(10) Pub. No.: US 2026/0212587 A1
(43) Pub. Date: Jul. 23, 2026

(54) METHOD AND APPARATUS FOR 3D SPATIAL ENHANCEMENT

(71) Applicants: Electronics and Telecommunications Research Institute, Daejeon (KR); The Trustees of Indiana University, Bloomington, IN (US)

(72) Inventors: Soon Heung JUNG, Daejeon (KR); Juhyung HA, Bloomington, IN (US); David J. CRANDALL, Bloomington, IN (US); Alimoor REZA, Bloomington, IN (US); Vibhas VATS, Bloomington, IN (US)

(73) Assignees: Electronics and Telecommunications Research Institute, Daejeon (KR); The Trustees of Indiana University, Bloomington, IN (US)

(21) Appl. No.: 19/456,176

(22) Filed: Jan. 22, 2026

(30) Foreign Application Priority Data
Jan. 22, 2025 (KR) 10-2025-0009857
Jan. 16, 2026 (KR) 10-2026-0009281

(51) Int. Cl. G06T 15/08; G06T 3/4053

(52) U.S. Cl. CPC G06T 15/08; G06T 3/4053

(57) ABSTRACT

A method for reconstructing 3D spatial data, the method comprising: generating a first voxel, which is a hybrid voxel representation, by quantizing input 3D spatial data to a predetermined resolution, wherein the first voxel includes occupancy information indicating a presence or absence of a point within a specific voxel and offset vector field information specifying a 3D displacement from a center of specific voxel to the nearest surface point; generating a second voxel with increased resolution based on the first voxel using a hybrid voxel network; reconstructing the 3D spatial data by reconstructing a position of a surface based on offset vector field information included in the second voxel.

### CROSS-REFERENCE TO RELATED APPLICATIONS

This application claims the benefit of earlier filing date and right of priority to Korean Application No. 10-2025-0009857, filed on Jan. 22, 2025, Korean Application No. 10-2026-0009281, filed on Jan. 16, 2026, the contents of which are all hereby incorporated by reference herein in their entirety.

### TECHNICAL FIELD

The present disclosure relates to a method for improving the quality of 3D spatial data and a device for performing the same.

### BACKGROUND

There is a growing interest in improving the quality of 3D data, which is crucial for applications such as computer graphics, CAD, medical imaging, and virtual reality.

This has led to the development of techniques aimed at managing computational complexity while improving the quality and fidelity of 3D representations. For example, general point cloud upsampling aims to improve the density and quality of point clouds from noisy and sparse inputs. However, general point cloud-based 3D spatial data compression and reconstruction techniques often suffer from limited scalability and computational efficiency and rely on computations not optimized for large-scale data processing.

Meanwhile, general voxel-based compression and reconstruction techniques can offer a promising alternative in terms of computational efficiency by leveraging a structured grid representation of 3D space. They are designed for efficient 3D convolution operations, and the number of voxels can dynamically adapt to the structure of the 3D data, providing greater flexibility in scene completion. However, general voxel-based compression and reconstruction techniques suffer from significant limitations due to the quantization step. While quantization facilitates structured voxel encoding, it can lead to a loss of precision in spatial accuracy.

### SUMMARY

The object of the present disclosure is to provide a method for representing voxels based on occupancy and offset vector fields (OVFs).

The object of the present disclosure is to provide an operational voxel expansion method.

The object of the present disclosure is to provide a method for pruning voxels based on unsigned distance fields (UDFs).

The object of the present disclosure is to provide a method for learning an implicit topology based on unsigned distance fields and offset vector fields.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for reconstructing 3D spatial data, the method comprising: generating a first voxel, which is a hybrid voxel representation, by quantizing input 3D spatial data to a predetermined resolution, wherein the first voxel includes occupancy information indicating a presence or absence of a point within a specific voxel and offset vector field information specifying a 3D displacement from a center of specific voxel to the nearest surface point; generating a second voxel with increased resolution based on the first voxel using a hybrid voxel network; reconstructing the 3D spatial data by reconstructing a position of a surface based on offset vector field information included in the second voxel.

In the method for reconstructing 3D spatial data according to the present disclosure, the input 3D spatial data includes a point cloud.

In the method for reconstructing 3D spatial data according to the present disclosure, the position of the surface is reconstructed by adding an offset vector to center coordinates of the specific voxel.

In the method for reconstructing 3D spatial data according to the present disclosure, generating the second voxel is characterized by performing a sparse convolution operation.

In the method for reconstructing 3D spatial data according to the present disclosure, generating the second voxel comprises expanding a candidate voxel region by switching empty neighboring voxels of the first voxel to an active state.

In the method for reconstructing 3D spatial data according to the present disclosure, generating the second voxel comprises performing pruning on voxels positioned at a certain distance or more from the surface based on unsigned distance field information.

In the method for reconstructing 3D spatial data according to the present disclosure, generating the second voxel comprises performing implicit topological learning based on the offset vector field information and unsigned distance field information.

In the method for reconstructing 3D spatial data according to the present disclosure, generating the second voxel comprises upscaling the resolution of the second voxel to a resolution higher than the predetermined resolution.

In the method for reconstructing 3D spatial data according to the present disclosure, generating the second voxel comprises training the hybrid voxel network to minimize a loss function including at least one of an occupancy loss, an unsigned distance field loss, and an offset vector field loss.

In the method for reconstructing 3D spatial data according to the present disclosure, the occupancy loss is calculated using a Dice loss based on an actual occupancy value, a predicted occupancy value, and a number of active voxels, the unsigned distance field loss is calculated using an L1 loss based on an actual unsigned distance and a predicted unsigned distance, and the offset vector field loss is calculated using an L1 loss between an actual offset vector and a predicted offset vector.

In the method reconstructing 3D spatial data according to the present disclosure, the second voxel includes occupancy information, offset vector field information, and unsigned distance field information.

In accordance with an aspect of the present disclosure, the above and other objects can be accomplished by the provision of an apparatus for reconstructing 3D spatial data, the apparatus comprising: one or more transceivers; one or more memories; and one or more processors, wherein the one or more processors being configured to: generate a first voxel, which is a hybrid voxel representation, by quantizing input 3D spatial data to a predetermined resolution, wherein the first voxel includes occupancy information indicating a presence or absence of a point within a specific voxel and offset vector field information specifying a 3D displacement from a center of specific voxel to the nearest surface point; generate a second voxel with increased resolution based on the first voxel using a hybrid voxel network; reconstruct the 3D spatial data by reconstructing a position of a surface based on offset vector field information included in the second voxel.

In the apparatus for reconstructing 3D spatial data according to the present disclosure, the input 3D spatial data includes a point cloud.

In the apparatus for reconstructing 3D spatial data according to the present disclosure, the position of the surface is reconstructed by adding an offset vector to center coordinates of the specific voxel.

In the apparatus for reconstructing 3D spatial data according to the present disclosure, the hybrid voxel network performs a sparse convolution operation.

In the apparatus for reconstructing 3D spatial data according to the present disclosure, the hybrid voxel network comprises voxel completion network, the voxel completion network expands a candidate voxel region by switching empty neighboring voxels of the first voxel to an active state.

In the apparatus for reconstructing 3D spatial data according to the present disclosure, the hybrid voxel network comprises voxel completion network, and the voxel completion network performs pruning on voxels positioned at a certain distance or more from the surface based on unsigned distance field information.

In the apparatus for reconstructing 3D spatial data according to the present disclosure, the hybrid voxel network performs implicit topological learning based on the offset vector field information and unsigned distance field information.

In the apparatus for reconstructing 3D spatial data according to the present disclosure, the hybrid voxel network comprises super-resolution network, the super-resolution network performs upscaling the resolution of the second voxel to a resolution higher than the predetermined resolution.

In accordance with an aspect of the present disclosure, the above and other objects can be accomplished by the provision of the one or more non-transitory computer-readable medium storing one or more instructions, wherein the one or more instructions, when executed by one or more processors, are configured to control an apparatus for reconstructing 3D spatial data to perform an operation, wherein the operation comprises: generating a first voxel, which is a hybrid voxel representation, by quantizing input 3D spatial data to a predetermined resolution, wherein the first voxel includes occupancy information indicating a presence or absence of a point within a specific voxel and offset vector field information specifying a 3D displacement from a center of specific voxel to the nearest surface point; generating a second voxel with increased resolution based on the first voxel using a hybrid voxel network; reconstructing the 3D spatial data by reconstructing a position of a surface based on offset vector field information included in the second voxel.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

FIG. 1 is a diagram illustrating occupancy, offset vector fields, and unsigned distance fields according to an embodiment of the present disclosure.

FIG. 2 is a flowchart of a hybrid voxel-based 3D spatial data reconstruction method according to one embodiment of the present disclosure.

FIG. 3 is a diagram illustrating the architecture of a voxel completion network and a resolution upscaling network according to one embodiment of the present disclosure.

FIG. 4 is a diagram illustrating the architecture of a voxel completion network and a super-resolution network according to one embodiment of the present disclosure.

FIG. 5 is a diagram illustrating an example of 3D spatial data reconstruction according to one embodiment of the present disclosure.

FIG. 6 is a diagram of an apparatus for performing a hybrid voxel-based 3D spatial data reconstruction method according to one embodiment of the present disclosure.

### DETAILED DESCRIPTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. As an example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. As an example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

General point cloud upsampling aims to improve the density and quality of point cloud from noisy and sparse inputs. However, general point cloud-based 3D spatial data compression and reconstruction techniques often suffer from limited scalability and computational efficiency and rely on computations not optimized for large-scale data processing.

Meanwhile, general voxel-based compression and reconstruction techniques can offer a promising alternative in terms of computational efficiency by leveraging a structured grid representation of 3D space. They are designed to efficient 3D convolution operations, and the number of voxels can dynamically adapt to the structure of the 3D data, providing greater flexibility in scene completion. However, general voxel-based compression and reconstruction techniques suffer from significant limitations due to the quantization step. Quantization, which discretizes a continuous 3D space into a discrete grid representation, supports structured voxel encoding, but can result in a loss of precision in spatial accuracy.

Accordingly, the present disclosure proposes a hybrid voxel-based 3D spatial data reconstruction method. The method of the present disclosure will now be described in detail.

The terms “first voxel,” “second voxel,” and “hybrid voxel” used in the present disclosure may be understood to refer not only to a single voxel, but also to one or more voxels or a set thereof. Furthermore, the term “feature” used in the present disclosure may refer to one or more features or a set of features.

A Hybrid voxel may include occupancy and offset vector fields (OVFs). A Hybrid voxel may also include unsigned distance fields (UDFs). Occupancy may be referred to as occupancy information and offset vector field(s) may be referred to as offset vector field information. Additionally, unsigned distance field(s) may be referred to as unsigned distance field information.

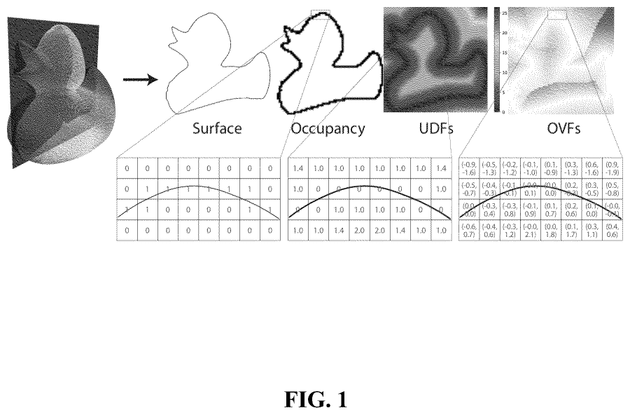

FIG. 1 is a diagram illustrating occupancy, offset vector fields, and unsigned distance fields according to an embodiment of the present disclosure.

Occupancy may refer to a binary flag indicating whether a point is present within a specific voxel. Occupancy may be defined in discrete grid coordinates.

An offset vector field may represent a 3D direction vector that specifies the displacement from each voxel center to the nearest surface point. Accurate surface positioning may be achieved based on the offset vector field.

The offset vector field Voff may be defined as in the following mathematical equation 1.

$${V}_{off} = {p}_{surf} - {p}_{coord} \qquad [ Mathematical equation 1 ]$$

Here, p_{surf} may represent the nearest surface point. p_{coord} may represent the center of a voxel in a discrete coordinate grid.

An unsigned distance field may represent the distance from each voxel center to the nearest surface. The unsigned distance field may provide continuous information about how far the interior, exterior, and surface boundaries of an object are from the voxel center. Since a UDF value closer to 0 indicates a voxel is closer to a surface, the network may implicitly learn the position and boundaries of surfaces through this field.

Pruning may be performed on voxels positioned at a certain distance or more from the surface based on an unsigned distance field. Pruning may improve computational efficiency.

By learning OVF and UDF, the normal and fine curvature of the surface can be accurately determined.

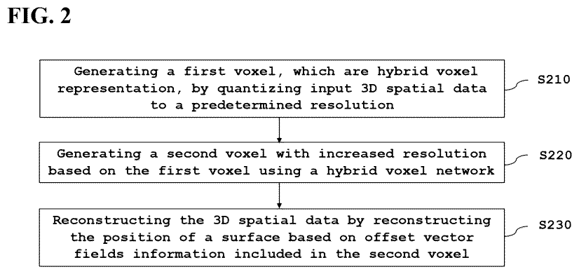

FIG. 2 is a flowchart of a hybrid voxel-based 3D spatial data reconstruction method according to one embodiment of the present disclosure.

Referring to FIG. 2, a first voxel, which is a hybrid voxel representation, is generated by quantizing input 3D spatial data to a predetermined resolution S210.

According to one embodiment of the present disclosure, a first voxel, which is voxelized 3D data, may be generated by mapping input 3D data to a grid structure. Here, the input 3D data may include a point cloud or the like. For example, the input 3D data may be a point cloud including 2048 points.

However, the above disclosed embodiments are merely examples and are not limited thereto.

A first voxel may also be called a hybrid voxel. A hybrid voxel may have a resolution of N\hat{ }3, where N may be an integer greater than or equal to 1. For example, N may be 128.

However, the above disclosed figures are only examples and are not limited thereto.

A hybrid voxel may contain discrete occupancy information and continuous offset vector field information.

The offset vector field Voff may be defined as in the mathematical equation 1 described above.

According to one embodiment of the present disclosure, a first voxel may have M channels, where M may be an integer greater than or equal to 1. For example, M may be 4.

According to one embodiment of the present disclosure, the occupancy may be a sparse tensor having N channels. For example, N may be 1. Here, the sparse tensor may refer to a data structure that does not store 0 values but stores non-zero values along with position information.

According to one embodiment of the present disclosure, the offset vector field may be a sparse tensor having P channels. For example, P may be 3.

Referring to FIG. 2, a second voxel with increased resolution of the 3D spatial data is generated based on the first voxel using a hybrid voxel network S220.

According to one embodiment of the present disclosure, a hybrid voxel network may include a voxel completion module and a super-resolution module.

According to one embodiment of the present disclosure, a sparse convolution operation may be performed on voxels using a hybrid voxel network. The convolution operation may be performed on non-empty voxels. The number of output occupied voxels may be limited by the number of non-empty input voxels. Here, the sparse convolution operation may be performed using TorchSparse, the Minkowski Engine, etc.

However, the above disclosed operation method is only an example and is not limited thereto.

According to one embodiment of the present disclosure, a voxel completion network may be based on a U-Net. The voxel completion network may receive a sparse first voxel as input, increase the density of voxels, and reconstruct the shape of missing voxels.

Specifically, sparse voxels may be input and downsampled to obtain low-resolution, compressed features. This allows for the extraction of coarse shape information. After extracting features through downsampling, reconstruction may be performed through upsampling to achieve the original resolution or higher. In this process, the voxel density can be increased.

However, the above disclosed embodiments are merely examples and are not limited thereto.

According to one embodiment of the present disclosure, expansion may be performed on the first voxel.

As described above, convolution operations can be performed on non-empty voxels. In this case, generation techniques such as subdivision may be used to supplement the input data. However, if the input 3D data is very sparse, the reconstructed data may still be incomplete. Therefore, by performing the expansion, empty voxels neighboring non-empty voxels may be additionally activated.

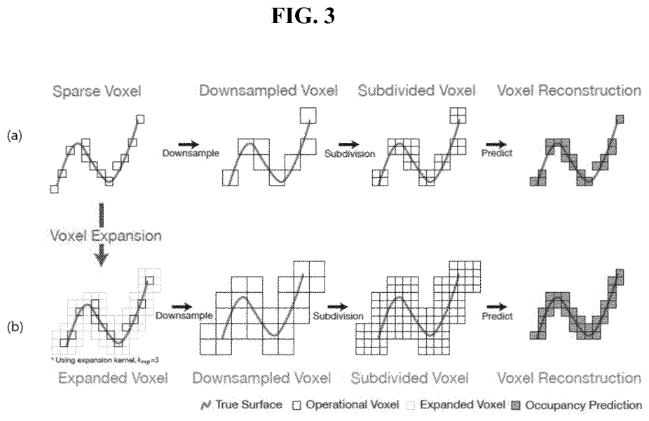

FIG. 3 is a diagram illustrating the architecture of a voxel completion network and a resolution upscaling network according to one embodiment of the present disclosure.

FIG. 3(a) shows the case where expansion is not performed, and FIG. 3(b) shows the case where expansion is performed.

Downsampling and/or subdivision may be performed on the input sparse voxels. Prediction may be performed on the downsampled and/or subdivided voxels, and the final 3D spatial data may be reconstructed.

Referring to FIG. 3(b), expansion may be performed using a predetermined expansion kernel. For example, an expansion kernel having an exponential function form may be used. Accordingly, empty neighboring voxels of a voxel may be activated, thereby expanding a candidate voxel region for voxel shape completion. The expansion may be performed in the voxel completion network of a hybrid voxel network.

Compared to the case where no expansion was performed, the number of voxels ultimately reconstructed increases with the expansion, as the number of non-empty voxels increases. Expansion of voxels may have the effect of improving the quality of the final 3D spatial data.

Meanwhile, according to one embodiment of the present disclosure, implicit topological learning can be performed based on offset vector fields and unsigned distance fields. Accordingly, the topological accuracy and surface precision of the completed shape can be maximized.

Specifically, surface boundaries may be implicitly identified by learning the distance from each voxel center to the nearest surface based on unsigned distance fields. Fine surface details and normal information may be captured by learning the direction and displacement from the voxel center to the surface based on an offset vector field.

Implicit topological learning may predict the exact shape of 3D spatial data beyond just filling in empty voxels.

According to one embodiment of the present disclosure, pruning of voxels may be performed based on unsigned distance fields, as voxels far from the surface may incur unnecessary burden in high-resolution computation.

Specifically, the predicted unsigned distance fields are identified through topological learning, and voxels with predicted values greater than a certain threshold (i.e., voxels far from the surface) can be disabled or removed.

According to one embodiment of the present disclosure, a super-resolution network may receive voxels with a fully formed shape and upscale its spatial resolution. The super-resolution network may increase the spatial resolution beyond the resolution of the input voxels. Accordingly, the fine geometric details of the fully formed voxels may be reconstructed.

According to one embodiment of the present disclosure, a hybrid voxel network may be trained using a loss function. The loss function may include N loss terms. For example, N may be 3.

Specifically, the loss function may include an occupancy loss L_{occ}, an UDF loss L_{udf}, and/or an OVF loss L_{ovf}.

For example, the occupancy loss may be calculated using Dice loss, as shown in mathematical equation 2 below.

$${L}_{occ} = 1 - \frac{2 {\sum }_{i}^{N} {p}_{i} {g}_{i}}{{\sum }_{i}^{N} {p}_{i} + {\sum }_{i}^{N} {g}_{i} + smooth} \qquad [ Mathematical equation 2 ]$$

Here, N may represent the number of active voxels. p may represent the predicted occupancy. g may represent the ground truth. smooth may represent a constant to prevent division by zero. For example, the UDF loss may be calculated using the L1 loss, as shown in mathematical equation 3 below.

$${L}_{udf} = \frac{1}{N} {\sum }_{i}^{N} \vert {y}_{udf}^{( i )} - {\hat{y}}_{udf}^{( i )} \vert \qquad [ Mathematical equation 3 ]$$

Here, y_{udf} may represent the true value for the distance from each voxel center to the nearest surface, and Ŷ_{udf} may represent the predicted value for the distance from each voxel center to the nearest surface.

For example, the OVF loss may be calculated using the L1 loss as shown in mathematical equation 4 below.

$${L}_{ovf} = \frac{1}{N} {\sum }_{i}^{N} \vert {v}_{ovf}^{( i )} - {\hat{v}}_{ovf}^{( i )} \vert \qquad [ Mathematical equation 4 ]$$

Here, v_{ovf} may represent the true value of the offset vector, and \hat{v}_{ovf} may represent the predicted value of the offset vector.

According to one embodiment of the present disclosure, as the first voxel or the expanded first voxel is input into the hybrid voxel network, a second voxel having M channels may be ultimately generated. Here, M may be an integer greater than or equal to 1. For example, M may be 5. The second voxel may include occupancy, offset vector fields, and unsigned distance fields.

Here, the occupancy may be a sparse tensor with N channels. For example, N may be 1. Here, the offset vector field may be a sparse tensor with P channels. For example, P may be 3. Here, the unsigned distance fields may be a sparse tensor with Q channels. For example, Q may be 1.

Referring to FIG. 2, the 3D spatial data is reconstructed by reconstructing a position of a surface based on offset vector field information included in the second voxel S230.

The second voxel may include occupancy, offset vector fields, and unsigned distance fields.

In this case, the location of the 3D spatial data may be reconstructed based on the offset vector field, as shown in the following mathematical equation 5.

$${p}_{surf} = {p}_{coord} + {v}_{off} \qquad [ Mathematical equation 5 ]$$

Here, p_{surf} may represent the nearest surface point. p_{coord} may represent the center of a voxel in a discrete coordinate grid. Voff may represent an offset vector.

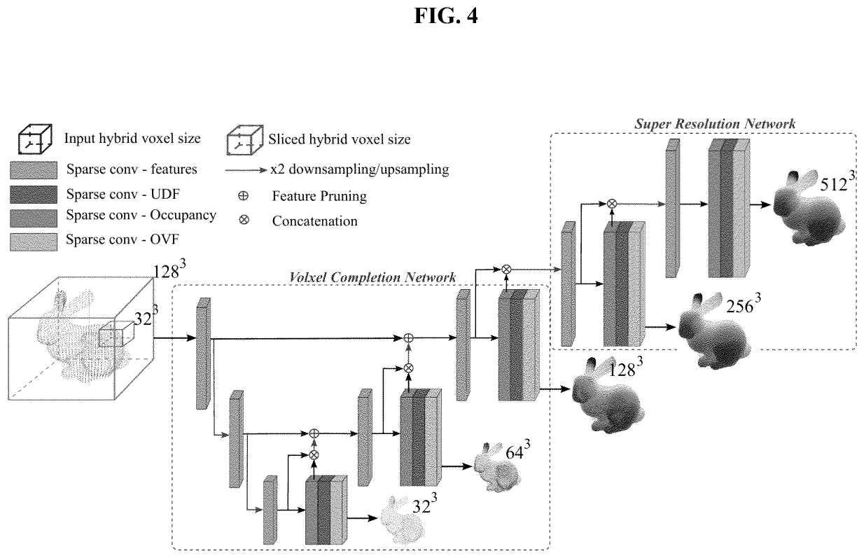

FIG. 4 is a diagram illustrating the architecture of a voxel completion network and a super-resolution network according to one embodiment of the present disclosure.

Referring to FIG. 4, a first voxel may be input into a voxel completion network. Referring to FIG. 4, an expansion for the first voxel may also be performed.

Meanwhile, referring to FIG. 4, voxels may be sliced into voxels of arbitrary resolution. Here, the sliced voxels may be input to a voxel completion network. This is to improve memory efficiency during network training. For example, voxels at level P may have a resolution of 128\hat{ }3. In this case, the sliced voxels may have a resolution of 32\hat{ }3.

Referring to FIG. 4, one or more features may be obtained after downsampling is performed N times for the first voxel or the expanded first voxel. Here, N may be 2. By performing downsampling, features having resolutions of level P−1 and level P−2 may be obtained. For example, the features may have a resolution of 64\hat{ }3 for level P−1 and 32\hat{ }3 for level P−2, respectively.

Referring to FIG. 4, an occupancy and offset vector field (OVF) may be derived from the feature with a resolution of level P−2. Additionally, an unsigned distance field (UDF) may also be derived from the feature. For the feature with a resolution of level P−2, upsampling may be performed again to generate a high-resolution output.

In this case, pruning may be performed on voxels positioned at a certain distance or more from the surface based on the unsigned distance field. By concatenating the pruned feature with the feature extracted during the downsampling process, the feature with a resolution of level P−1 may be reconstructed.

Referring to FIG. 4, the same process may be performed for feature with a resolution of level P−1, allowing feature with a resolution of level P to be reconstructed.

Referring to FIG. 4, the feature with a resolution of level P may be used as input to a super-resolution network to generate high-resolution output.

Referring to FIG. 4, a super-resolution network may perform upsampling on the feature having a resolution of level P−2 to obtain the feature having a resolution of level P−1. The upsampling may be performed through a sparse convolution operation.

Referring to FIG. 4, through upsampling and sparse convolution operations, the super-resolution network may generate features that exceed the resolution of the input voxels (e.g., level P+1, level P+2, etc.), and perform progressive refinement to recover fine geometric details. Here, the features may have a resolution of 256\hat{ }3 for level P+1 and 512\hat{ }3 for level P+2, respectively.

However, the above disclosed embodiments are merely examples and may have different values.

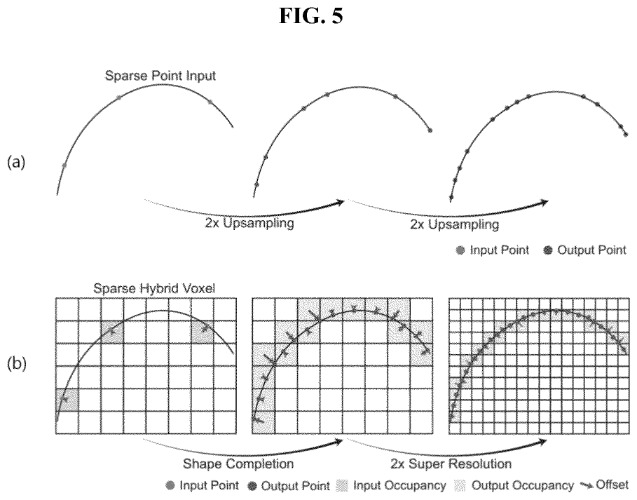

FIG. 5 is a diagram illustrating an example of 3D spatial data reconstruction according to one embodiment of the present disclosure.

FIG. 5(a) illustrates an example of 3D spatial data reconstruction based on point cloud upsampling.

FIG. 5(b) illustrates an example of 3D spatial data reconstruction based on hybrid voxels.

General point cloud upsampling aims to improve the density and quality of point clouds from noisy and sparse inputs. However, as illustrated in FIG. 5(a), it has limitations, as it can only generate a fixed number of points per inference, regardless of model complexity. Furthermore, it is not optimized for large-scale data processing, resulting in low computational efficiency.

Meanwhile, typical voxel-based compression and reconstruction techniques utilize a structured grid representation of 3D space, offering superior computational efficiency. Furthermore, the number of voxels can dynamically adapt to the structure of the 3D data, providing greater flexibility in scene completion. However, general voxel-based compression and reconstruction techniques suffer from significant limitations due to the quantization step. Quantization, which discretizes a continuous 3D space into a discrete grid representation, supports structured voxel encoding, but may result in a loss of precision in spatial accuracy.

Referring to FIG. 5(b), the gap between discrete voxel grids and continuous surface details can be effectively bridged through voxel completion and super-resolution. This enables precise surface reconstruction while enabling efficient processing using sparse convolution operations.

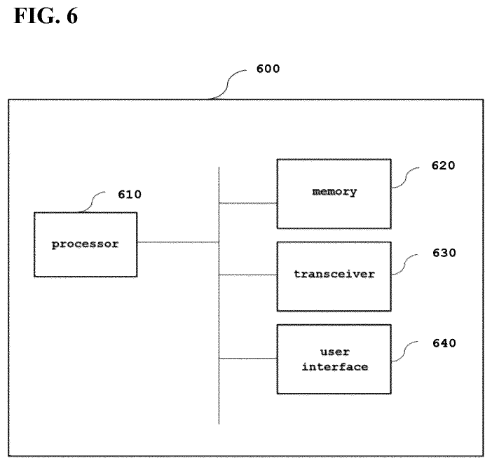

FIG. 6 is a diagram of an apparatus for performing a hybrid voxel-based 3D spatial data reconstruction method according to one embodiment of the present disclosure.

The apparatus 600 may include one or more processors 610, one or more memories 620, one or more transceivers 630, one or more user interfaces 640, etc. The memory 620 may be included in the processor 610 or may be configured separately. The memory 620 may store instructions that cause the apparatus 600 to perform operations when executed by the processor 610. The transceiver 630 may transmit and/or receive signals, data, etc. that the apparatus 600 exchanges with other entities. The user interface 640 may receive an input of the user for the apparatus 600 or provide an output of the apparatus 600 to the user. Among the components of the apparatus 600, components other than the processor 610 and the memory 620 may not be included in some cases, and other components not shown in FIG. 6 may be included in the apparatus 600.

The processor 610 may be configured to cause the apparatus 600 to perform operations of the device according to various examples of the present disclosure. Although not illustrated in FIG. 6, the processor 610 may be configured as a set of modules each performing a function. The modules may be configured in the form of hardware and/or software.

The processor 610 of the apparatus 600 can generally support/perform operations that are configured to generate a first voxel, which is a hybrid voxel representation, by quantizing input 3D spatial data to a predetermined resolution, wherein the first voxel includes occupancy information indicating a presence or absence of a point within a specific voxel and offset vector field information specifying a 3D displacement from a center of specific voxel to the nearest surface point; generate second voxel with increased resolution based on the first voxel using a hybrid voxel network; reconstruct the 3D spatial data by reconstructing a position of a surface based on offset vector field information included in the second voxel.

In this regard, a detailed explanation has been provided with reference to FIG. 2, and a detailed explanation will be omitted here to avoid redundant explanation.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for reconstructing 3D spatial data, the method comprising:
generating a first voxel, which is a hybrid voxel representation, by quantizing input 3D spatial data to a predetermined resolution,
wherein the first voxel includes occupancy information indicating a presence or absence of a point within a specific voxel and offset vector field information specifying a 3D displacement from a center of specific voxel to the nearest surface point;
generating a second voxel with increased resolution based on the first voxel using a hybrid voxel network;
reconstructing the 3D spatial data by reconstructing a position of a surface based on offset vector field information included in the second voxel.

2. The method of claim 1, wherein the input 3D spatial data includes a point cloud.

3. The method of claim 1, wherein the position of the surface is reconstructed by adding an offset vector to center coordinates of the specific voxel.

4. The method of claim 1, wherein generating the second voxel is characterized by performing a sparse convolution operation.

5. The method of claim 1, wherein generating the second voxel comprises:
expanding a candidate voxel region by switching empty neighboring voxels of the first voxel to an active state.

6. The method of claim 1, wherein generating the second voxel comprises:
performing pruning on voxels positioned at a certain distance or more from the surface based on unsigned distance field information.

7. The method of claim 1, wherein generating the second voxel comprises:
performing implicit topological learning based on the offset vector field information and unsigned distance field information.

8. The method of claim 1, wherein generating the second voxel comprises:
upscaling the resolution of the second voxel to a resolution higher than the predetermined resolution.

9. The method of claim 1, wherein generating the second voxel comprises:
training the hybrid voxel network to minimize a loss function including at least one of an occupancy loss, an unsigned distance field loss, and an offset vector field loss.

10. The method of claim 9, wherein the occupancy loss is calculated using a Dice loss based on an actual occupancy value, a predicted occupancy value, and a number of active voxels,
wherein the unsigned distance field loss is calculated using an L1 loss based on an actual unsigned distance and a predicted unsigned distance, and
wherein the offset vector field loss is calculated using an L1 loss between an actual offset vector and a predicted offset vector.

11. The method of claim 1, wherein the second voxel includes occupancy information, offset vector field information, and unsigned distance field information.

12. An apparatus for reconstructing 3D spatial data, the apparatus comprising:
one or more transceivers;
one or more memories; and
one or more processors, wherein the one or more processors being configured to:
generate a first voxel, which is a hybrid voxel representation, by quantizing input 3D spatial data to a predetermined resolution,
wherein the first voxel includes occupancy information indicating a presence or absence of a point within a specific voxel and offset vector field information specifying a 3D displacement from a center of specific voxel to the nearest surface point;
generate a second voxel with increased resolution based on the first voxel using a hybrid voxel network;
reconstruct the 3D spatial data by reconstructing a position of a surface based on offset vector field information included in the second voxel.

13. The apparatus of claim 12, wherein the input 3D spatial data includes a point cloud.

14. The apparatus of claim 12, wherein the position of the surface is reconstructed by adding an offset vector to center coordinates of the specific voxel.

15. The apparatus of claim 12, wherein the hybrid voxel network performs a sparse convolution operation.

16. The apparatus of claim 12, wherein the hybrid voxel network comprises voxel completion network, and
wherein the voxel completion network expands a candidate voxel region by switching empty neighboring voxels of the first voxel to an active state.

17. The apparatus of claim 12, wherein the hybrid voxel network comprises voxel completion network, and
wherein the voxel completion network performs pruning on voxels positioned at a certain distance or more from the surface based on unsigned distance field information.

18. The apparatus of claim 12, wherein the hybrid voxel network performs implicit topological learning based on the offset vector field information and unsigned distance field information.

19. The method of claim 12, wherein the hybrid voxel network comprises super-resolution network, and
wherein the super-resolution network performs upscaling the resolution of the second voxel to a resolution higher than the predetermined resolution.

20. A non-transitory computer-readable medium storing one or more instructions, wherein the one or more instructions, when executed by one or more processors, are configured to control an apparatus for reconstructing 3D spatial data, comprising:
generating a first voxel, which is a hybrid voxel representation, by quantizing input 3D spatial data to a predetermined resolution,
wherein the first voxel includes occupancy information indicating a presence or absence of a point within a specific voxel and offset vector field information specifying a 3D displacement from a center of specific voxel to the nearest surface point;
generating a second voxel with increased resolution based on the first voxel using a hybrid voxel network;
reconstructing the 3D spatial data by reconstructing a position of a surface based on offset vector field information included in the second voxel.
